(19) United States
(12) Patent Application Publication
(10) Pub. No.: US 2026/0109110 A1
(43) Pub. Date: Apr. 23, 2026

(54) SYSTEM AND METHOD FOR DYNAMIC SUBSTRATE VAT FOR ADDITIVE MANUFACTURING

(71) Applicant: Advanced Printed Electronic Solutions LLC, Fishkill, NY (US)

(72) Inventor: Richard Neill, Garrison, NY (US)

(21) Appl. No.: 19/361,153

(22) Filed: Oct. 17, 2025

Related U.S. Application Data
(60) Provisional application No. 63/709,095, filed on Oct. 18, 2024.
(60) Provisional application No. 63/730,696, filed on Dec. 11, 2024.

(51) Int. Cl. B29C 64/245; B29C 64/129; B29C 64/321; B33Y 30/00; B33Y 40/00

(52) U.S. Cl. CPC B29C 64/245; B29C 64/129; B29C 64/321; B33Y 30/00; B33Y 40/00

(57) ABSTRACT

A dynamic VAT for additive manufacturing is provided. The dynamic VAT including a container VAT and a substrate VAT movably disposed in the container VAT. The substrate VAT having a plurality of apparatus to allow an additive manufacturing liquid materials in the container VAT to flow into and out of the substrate VAT. The dynamic VAT also includes one or more actuators operably coupled to the substrate VAT for moving the substrate VAT in at least a Z direction relative to the container VAT. The one or more actuators move the substrate VAT between a first position submerged in the liquid material and a second position emerged from the liquid material.

### CROSS-REFERENCE TO RELATED APPLICATIONS

The present application claims priority to U.S. Provisional Ser. No. 63/709,095, filed Oct. 18, 2024, and titled “System and Method for Dynamic Substrate VAT for Volumetric Additive Manufacturing”, and U.S. Provisional Ser. No. 63/730,696 , filed Dec. 11, 2024, and titled “System and Method for Dynamic Substrate VAT for Volumetric Additive Manufacturing”, the contents of which are hereby incorporated by reference in their entirety.

### BACKGROUND

Volumetric additive manufacturing (VAM) and other digital lithographic based printers utilize a VAT or other containers to hold liquid resin, liquid substrates, and other liquid state materials that are selectively catalyzed or polymerized (turned from the liquid state to a solid) to form complex 3-dimensional structures. This is process also referred to as “VAT photopolymerization,” a category of additive manufacturing processes that create 3D objects by selectively curing resin or other materials through targeted light-activated polymerization methods.

VAM based printers can fabricate objects from all points within a VAT medium, not layer-by-layer as with other additive manufacturing (AM) methods (FFF, SLA, etc. as examples) essentially forming the 3D object all at once. This technique is capable of producing parts without supporting structures and is also capable of overprinting around existing structures. Unlike layer-based AM approaches, VAM based methods drastically reduce the time required to fabricate a 3D object. Other digital lithographic based printers can also fabricate 2.5D and 3D structures simultaneously, but with materials that vary in characteristic from one region to another region or any given voxel or set of voxels.

Current AM systems and methods making use of some liquid material VAT that contains an object in formation are limited in that the fabrication of the 3D object is wholly contained within the VAT container as illustrated. This limits the ability to incorporate additional manufacturing processes and/or orchestration and use of other tools, print processes, and methods to process or manufacture the object and/or to create more complex 3D objects and functionalities.

Accordingly, what is needed is a system which overcomes these limitations by enabling the fabrication process to include dynamic movement and positioning of the 3D object substrate to programmatically defined positions within or outside the VAT container liquid material region. In this manner the substrate can be processed, post-processed, or functionalized by one or more tools and manufacturing processes, during one or more time/event points during the overall fabrication process.

### SUMMARY

According to some embodiments of the present disclosure, a dynamic VAT for additive manufacturing is provided. The dynamic VAT including a container VAT and a substrate VAT movably disposed in the container VAT. The substrate VAT having a plurality of apparatus to allow an additive manufacturing process where liquid in the container VAT flows into and out of the substrate VAT. The dynamic VAT also includes one or more actuators operably coupled to the substrate VAT for moving the substrate VAT in at least a Z direction relative to the container VAT. The one or more actuators move the substrate VAT between a first position submerged in the liquid and a second position emerged from the liquid.

### BRIEF DESCRIPTION OF DRAWINGS

The subject matter, which is regarded as the disclosure, is particularly pointed out in the specification. The foregoing and other features, and advantages of the disclosure are apparent from the following detailed description taken in conjunction with the accompanying drawings in which like reference numerals refer to like elements throughout the different views:

FIGS. 1A-2B are perspective views of prior art substrate VATS;

FIGS. 3A-3C are a perspective, top, and side view of a dynamic VAT with a dynamic actuation substrate VAT;

FIGS. 4A-4C are schematic views of various aperture configurations on a substrate VAT;

FIG. 5 is a perspective view of a dynamic VAT with a dynamic magnetic actuation substrate VAT;

FIG. 6 is a perspective view of a dynamic VAT with a substrate VAT movable in an X, Y, Z, A pitch and B rotation directions;

FIGS. 7A-7B are perspective views of a dynamic VAT with alternate VAT geometry;

FIGS. 8A-8B are schematic view of various container VAT and substrate VAT array and matrix configurations;

FIG. 9 is a perspective view of a dynamic VAT as part of 3D motion platform;

FIG. 10 illustrates how dynamic VAT facilities integration of a VAT based tool process with other tools and/or manufacturing processes;

FIGS. 11A-11C are perspective view of a dynamic VAT with a substrate VAT being raised/lowered out of/into a liquid at varying positions for AM and processing by other tools;

FIG. 12 is a perspective view of a dynamic VAT with a substrate VAT with a varying build platform geometry;

FIG. 13 is a perspective view of the substrate VAT being decoupled from the dynamic VAT for further processing in a secondary system;

FIG. 14 is a perspective view of a dynamic VAT with a mechanical actuator for positioning the substrate VAT; and

FIG. 15 is a perspective view of a dynamic VAT with a fixture for positioning the substrate VAT.

### DETAILED DESCRIPTION

The subject matter disclosed herein relates to dynamic VAT and substrate positioning systems. In particular, dynamic control of the VAT containing the substrate used in AM applications utilizing VAT based build platforms to enable additional additive manufacturing processes to be combined with AM applications through dynamic positioning of the substrate during fabrication under program control.

It should be appreciated that while the present disclosure is referencing AM and volumetric additive manufacturing processes, the application of dynamic VAT is not limited to VAM and can be utilized for any manufacturing process where a substrate is formed with a liquid material process, is encapsulated, incorporated, coupled, or coated by at least one liquid state material. For example, other non-VAM manufacturing processes such as, but not limited to, SLA, SLS, sintering, 2.5D or 3D digital lithographic methods, or substrate coating processes may utilize the methods herein with no loss of generality. In an embodiment, the 2.5D or 3D digital lithographic method may be configured in the manner described in U.S. patent application Ser. No. 19/355,538 filed Oct. 10, 2025 entitled “System and Method for High-Throughput Adaptive Additive Manufacturing”, the contents of which are incorporated by reference herein.

In some embodiments, during the AM fabrication process, it may be desirable to suspend the AM fabrication and functionalize the in-process substrate for the deposition of a printed conductive circuit, place electronic components, post-process (curing or cleaning) some portion of the substrate, or otherwise perform some manufacturing operation on the substrate. The system and method described shall actuate (through one or more embodiments herein) a substrate carrier, so that its new position is accessible to the one or more tool and processes required. In an embodiment, the liquid state material may be removed and replaced back through a vacuum/pump system to facilitate the manufacturing process. In an embodiment, the vacuum/pump system adds or maintains liquid material to the container VAT to maintain sufficient material for continuous manufacturing processes. In yet another embodiment, a level sensor within the substrate VAT senses the current level of liquid material and sends a signal back to the controller to activate the vacuum/pump system. Upon completion of the non-VAT based process, the substrate (through one or more embodiments herein) may be returned to its original position or a new desired location where the VAT based AM fabrication is resumed. Alternatively, the substrate can be moved to a new tool or process, where fabrication may resume at some other tool or manufacturing process if the AM portion of the fabrication is complete. In this method, one or more iterative manufacturing processes may be interleaved with the AM process, such as a VAM or other digital lithographic based process which is useful for printing and/or overprinting complex multi-functional structures, facilitate mass-customization, fabricate 3D printed electronics, fabricate electronic/electrical connectors, bio-printing, and countless applications found in electronics, medical, and numerous others.

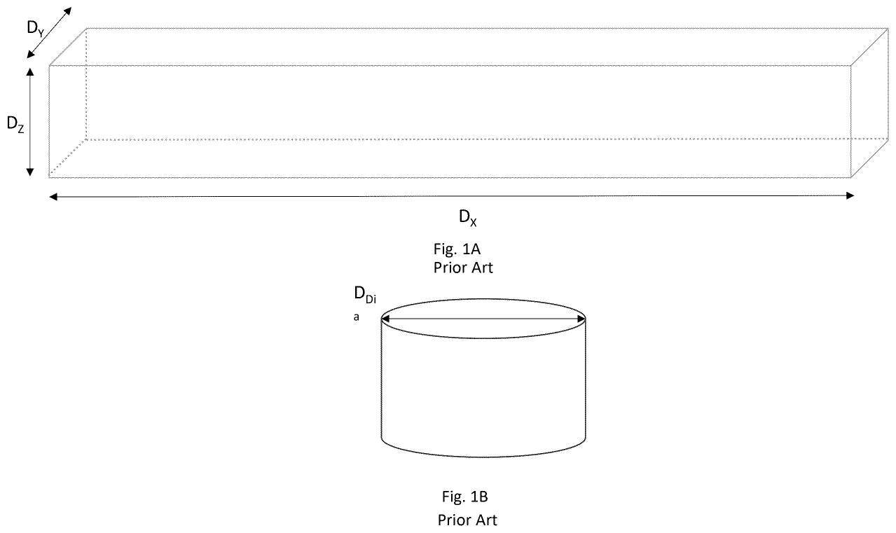

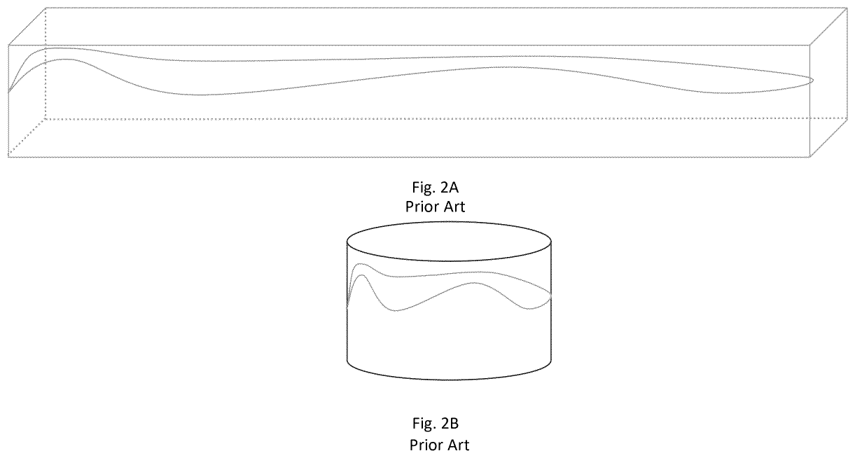

Referring now to FIGS. 1A-2B, shown are prior art figures illustrate typical VAT container geometries. The VAT containers include various shapes and geometries used to contain the liquid materials (such as resin or other liquid material chemistries suitable for additive manufacturing) used in the VAM fabrication process. However, these VAT structures lack a way to easily temporarily evacuate the liquid material or raise and lower the target 3D object being fabricated into and out of the liquid materials during fabrication. FIG. 2A illustrates the VAT container filled with a material.

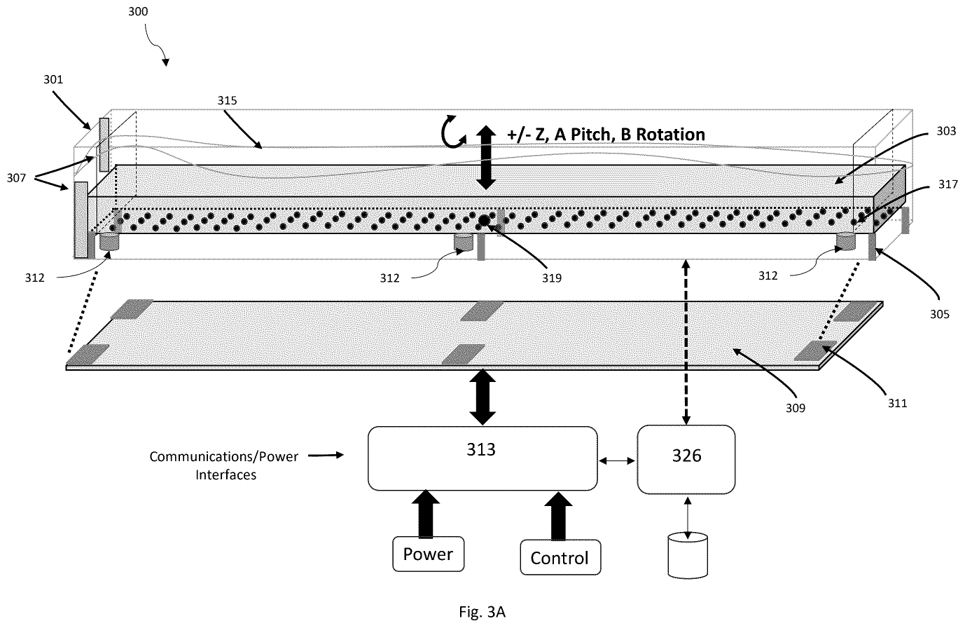

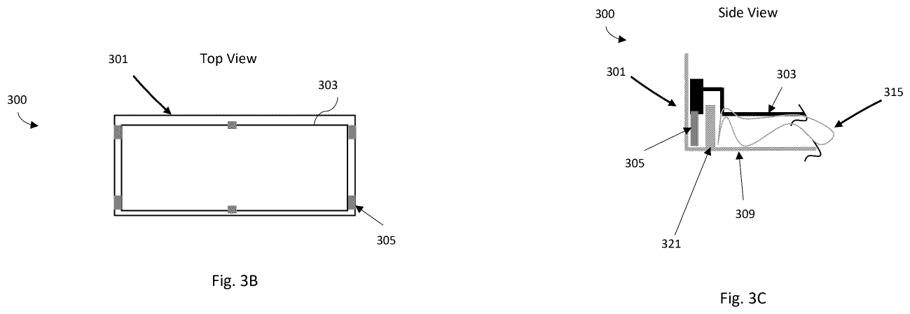

Referring now to FIGS. 3A-3C, shown are perspective, top, and side views of a dynamic VAT 300 with dynamic mechanical motion control according to some embodiments of the present disclosure. The dynamic VAT 300 may include A, B pitch/rotation capabilities. The dynamic VAT 300 may include a container VAT 301 and a substrate VAT 303 nested inside the container VAT 301. The container VAT 301 may be any cuboid or cylindrical shape, and the substrate VAT 303 may be any cuboid or cylindrical shape which can be nested in the container VAT 301. In some embodiments the dynamic VAT 300, container VAT 301, and substrate VAT 303 may adhere to JEDEC standards for its geometry based on JEDEC matrix and substrate carrier trays used within the semiconductor industry. In this manner, ease of handling and integration with additional manufacturing processes, such as those related to semiconductor packaging is supported.

In an embodiment, the container or substrate VAT may be made of a material of various levels of transparency or wavelength selectivity, allowing for the control of laser or other optical light sources (in a plurality of wavelengths including UV as example) energy levels and penetration into the VAT geometry allowing for manipulation of the fabrication processes such as polymerization, catalyzation, and/or curing of the substrate object.

The substrate VAT 303 may be movable in the Z direction and/or have A pitch motion within the container VAT 301. One or more linear Z motion actuators 305 may be used to move the substrate VAT 303 in the Z direction. In some embodiments, where a plurality of Z motion actuators 305 are used, each of the Z motion actuators 305 may be individually addressable and controllable to enable portions of the substrate VAT 303 to be selectively raised, lowered, and rotated. For example, one or more Z motion actuators 305 may be used raise a first edge of the substrate VAT 303 while one or more other Z motions actuators 305 are used to lower a second edge of the substrate VAT 303 opposite the first edge in order to rotate or tilt the substrate VAT 303. In some embodiments, one or more guides 307 are positioned between the container VAT 301 and the substrate VAT 303 to prevent unwanted movement and facilitate desired movement of the substrate VAT 303 within the container VAT 301.

The container VAT 301 may be mounted on a VAT control frame and base platform 309 having one or more actuator control points/positional sensors 311 corresponding to the one or more linear Z motion actuators 305. The one or more actuator control points 311 may enable selective control of the Z motion actuator 305. In some embodiments, a VAT Z-A motion controller 313, having a power source and a controller, may be connected to the VAT control frame 309 to enable selective, automatic, and/or remote control of the linear Z motion actuators 305.

In some embodiments, communication with the dynamic VAT controller may be wireless such as Wi-Fi® (Wi-Fi Alliance of Austin, Texas) or Bluetooth® (Bluetooth Special Interest Group of Kirkland, Washington).

In some embodiments, the power source is an internal battery coupled to the VAT Z-A motion controller assembly and the battery is charged/recharged wirelessly.

In some embodiments, one or more sensors 312 are embedded in the container VAT 301 and/or the substrate VAT 303 to provide real-time measurements regarding the vibration and liquid 315 level. The measurements may then be used to make continuous +/−micro-adjustments to the substrate VAT 303 via the actuators 305 to compensate for any vibrations of the system and to level the liquid 315.

The substrate VAT 303 may be submerged in a liquid material 315 (e.g., liquid resin) for VAM applications in the container VAT 301. During the VAM process as a target 3D object is formed in the liquid 315 through VAT photopolymerization, the substrate VAT 303 may be actuated to raise the 3D object out of the liquid 315. As the substrate VAT 303 is raised, the liquid 315 drains out of the substrate VAT 303 into the container VAT 301 via material drain apertures 317 and substrate ejection/vacuum ports 319 in the substrate VAT 303. The substrate VAT 303 may then be lowered and the liquid 315 flows back into the substrate VAT 303 via the same apertures 317 and ejection/vacuum ports 319 the liquid 315 flowed out of. In this way, the 3D object can be exposed for further processed, for example, cleaning, curing, or using other additive manufacturing processes to fabricate features on the 3D object, and then re-submerged in the substrate for further VAM processing without the need to remove the 3D object from the dynamic VAT 300 system.

As shown in FIG. 3C, in some embodiments, the actuators 305 may be insulated from the liquid 315 by an interior wall 321 of the container VAT 301.

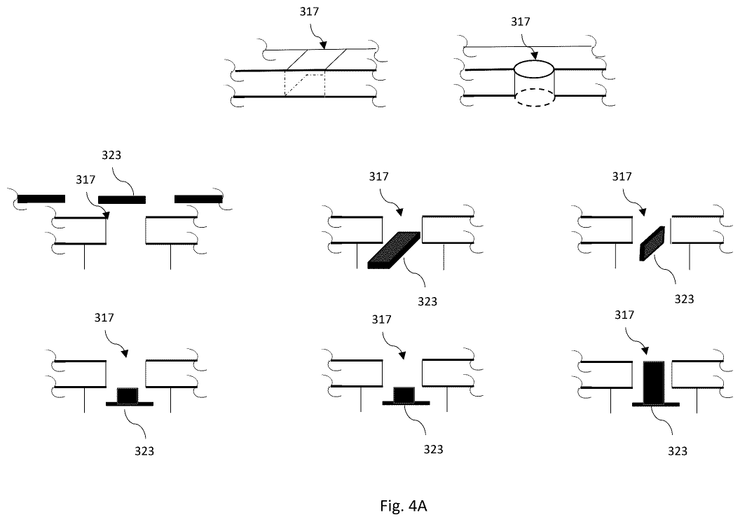

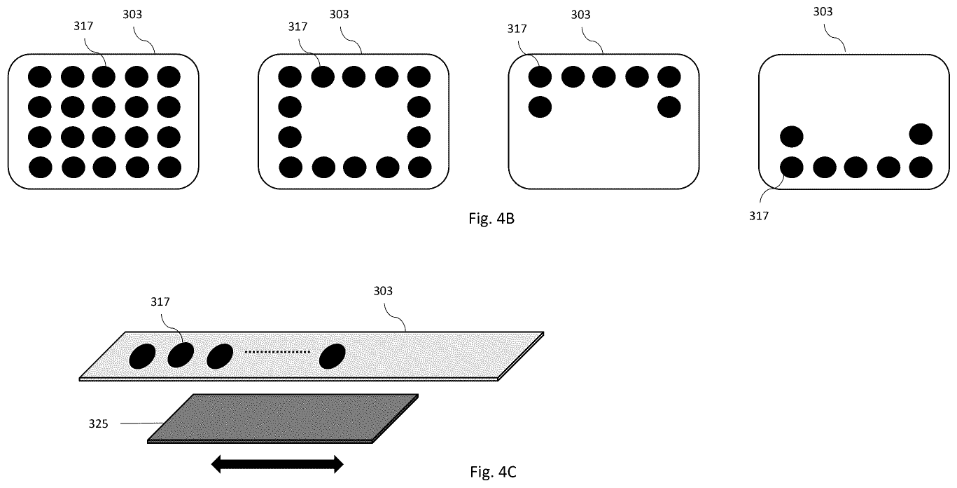

In some embodiments, the ejection/vacuum ports 319 are used to facilitate removal of completed substrates components or devices. In other embodiments, the ejection/vacuum ports 319 are utilized to fixate the completed substrate so they are in a fixed position during additional post processing. That is a vacuum is created below each of the substrates, such that the substrates remain in their position during transport or post-processing operations. Referring now to FIGS. 4A-4C, shown are various embodiments of material inlet/outlet aperture 317 configurations. FIG. 4A illustrates various embodiments to enable material inlet/outlet process while minimizing/eliminating exposure of container VAT material to cleaning and curing processes. In some embodiments, the apertures 317 may be rectangular, circular, or another polygonal shape suitable to allow the liquid 315 to drain from the substrate VAT 303. In some embodiments, the apertures 317 may include an insert 323 which partially covers the aperture 317. The insert 323 may restrict the flow of the liquid 315 through the aperture 317 and may obscure penetrating energy or substance from reaching the liquid 315. For example, when the substrate VAT 303 is raised out of the liquid 315 and the 3D printed object is being cleaned or cured, it may be desirable to prevent or reduce burs or substances cleaned off the 3D object or curing energy from reaching the liquid 315.

In some embodiments, the apertures 317 may be arranged in multiple configurations including number, location, shape, density, and distribution of the apertures 317 on the substrate VAT 303. In some embodiments, the apertures 317 may be occluded (fully covered) utilizing an actuated shutter 325 mechanism that is controllable and movable between an open and a closed position to seal and unseal the apertures 317. The shutter 325 may be actuated mechanically or magnetically.

In some embodiments additional material inlet/outlet aperture ports are coupled to the container VAT 301 to facilitate the removal or reloading of liquid materials using a vacuum/pump system 326. The vacuum/pump system is controlled by controller 313 to manage the amount of liquid material that is removed, replaced, or added under the orchestration of a platform control system. A level sensor may be incorporated within the substrate or container VAT to dynamically monitor the liquid material level state to facilitate the orchestration and control of the vacuum/pump system. When the fabrication process is completed, one or more apertures 317 may be utilized for fixating completed devices utilizing a vacuum pressure. In some instances, the substrate VAT may utilize one or more inlet/outlet aperture structures for use in fixating completed components during transport or post-processing operations by the vacuum control.

In some embodiments, the material inlet/outlet apertures may be formed over one layer within the substrate VAT, or multiple layers within the substrate VAT. In an embodiment, the various structures comprising the material inlet/outlet apertures may include inlet/outlet apertures that stack parallel to one another or positioned relative to one another so there are no overlapping apertures as illustrated in FIGS. 4A-C.

In an embodiment the structures forming the material inlet/outlet apertures 317 and their respective layer structures 309 may be fabricated from a material that selectively allows, partially allows, blocks, and/or partially blocks optical or light sources to control the level of energy absorption and exposure. The material may include various levels of transparency or wavelength selectivity, allowing for the control of laser or other optical light sources (in a plurality of wavelengths including UV as example) energy levels and penetration across the material inlet/outlet structures further allowing for manipulation of the fabrication processes such as polymerization, catalyzation, and/or curing of the substrate object.

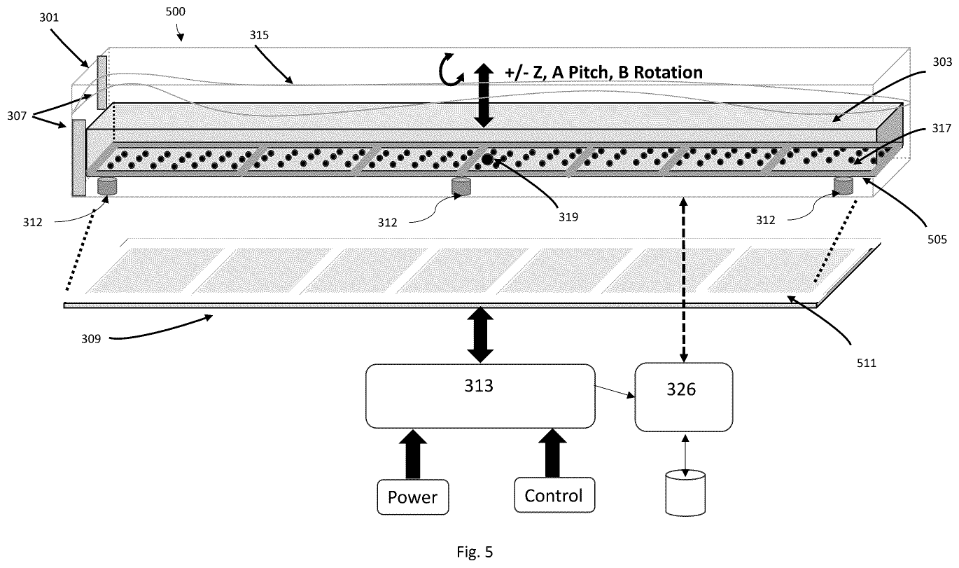

Referring now to FIG. 5, shown is a perspective view of a dynamic VAT 500 with dynamic magnetic motion control according to some embodiments of the present disclosure. The dynamic VAT 500 may be substantially similar to the dynamic VAT 300 discussed herein, except the dynamic VAT 500 uses a magnetic actuator 511 to control the movement of the substrate VAT 303. In such embodiments, the VAT control frame 309 has magnetic actuator regions 511 which are selectively controlled by the motion controller 313 to emit magnetic fields of varying strength. The magnetic fields interact with a magnetic motion frame 505 on bottom of the substrate VAT 303 to actuate the substrate VAT 303 in the Z, A, and B directions. For example, the magnetic actuator 511 may emit a uniform magnetic field to actuate the substrate VAT 303 in the Z direction or the magnetic actuator 511 may emit a non-uniform magnetic field to selective raise one side of the substrate VAT 303 causing rotation or tilt in the A, B pitch motion direction. As shown in FIG. 5, the substrate VAT 303 may be a cuboid.

In some embodiments, data from sensors in conjunction with the application of the non-uniform magnetic field or mechanical-based actuators can be used to control and avoid spillage of the liquid material.

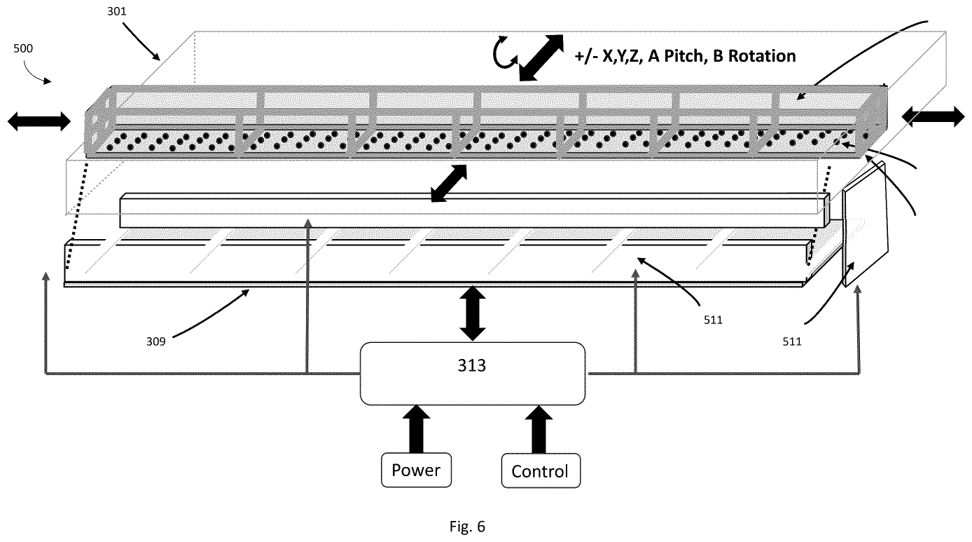

Referring now to FIG. 6, shown is a perspective view of a dynamic VAT 600 with dynamic magnetic motion control in the X, Y, Z, and A pitch directions according to some embodiments of the present disclosure. The dynamic VAT 600 may be substantially similar to the dynamic VAT 500 discussed herein, except the dynamic VAT 600 includes the magnetic motion frame 505 on bottom and sides of the substrate VAT 303 and incudes magnetic actuators 511 on the VAT control frame 309 and to the sides of the container VAT 301. In such embodiments, the inclusion of the magnetic motion frame 505 on the sides of the substrate VAT 303 and the magnetic actuators 511 to the sides of the container VAT 301, the substrate VAT 303 is movable in the X, Y, Z, and A pitch directions within the container VAT 301. This may be desirable to be able to support multiple substrate VATs 303 within the same container VAT 301 or to support use of substrate VATs 303 having various shapes and sizes within a given container VAT 301. The dynamic VAT 600 may include a cuboid substrate VAT 303.

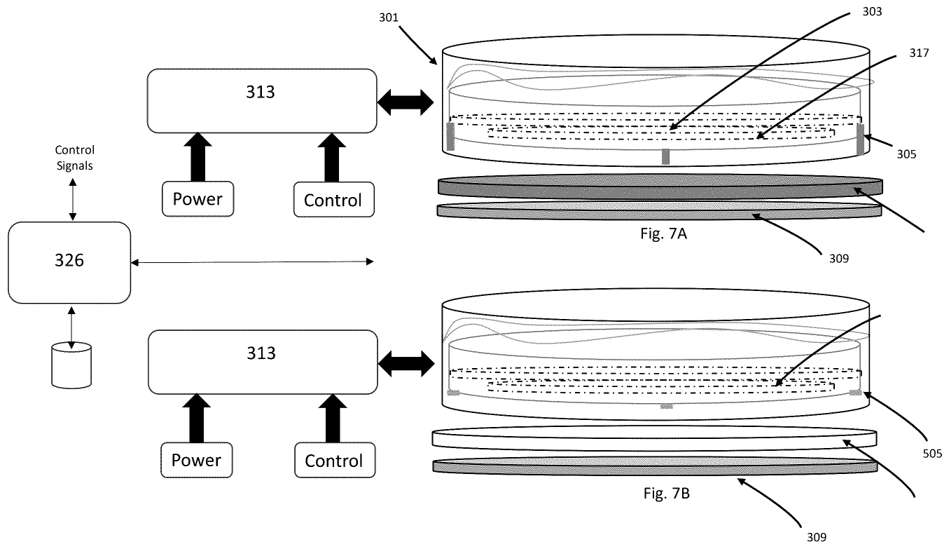

Referring now to FIG. 7A, shown is a perspective view of a dynamic VAT 300 with a cylindrical VAT configuration according to some embodiments of the present disclosure. In some embodiments, the dynamic VAT 300 may have a circular or cylindrical shape including the container VAT 301 and the substrate VAT 303. In some embodiments, the actuators 305 may be used to rotate the substrate VAT 303, e.g., clockwise or counterclockwise, within the container VAT 301.

Referring to FIG. 7A and FIG. 7B., in an embodiment, the circular motion and/or rotation of the dynamic VAT 300 may be utilized to establish a uniform liquid material level through a “spin” process controlled by the VAT motion controller 313. In another embodiment, the dynamic VAT may utilize circular motion and/or rotation in conjunction with the vacuum/pump system illustrated to define a specific liquid material layer thickness across the substrate geometry.

Referring now to FIG. 7B, shown is perspective a view of a dynamic VAT 500 with a cylindrical VAT configuration according to some embodiments of the present disclosure. In some embodiments, the dynamic VAT 500 may have a circular or cylindrical shape including the container VAT 301 and the substrate VAT 303. In some embodiments, the magnetic actuators 511 may be used to generate a magnetic field to interact with the magnetic motions frame 505 on the substrate VAT 303 to rotate the substrate VAT 303, e.g., clockwise or counterclockwise, within the container VAT 301.

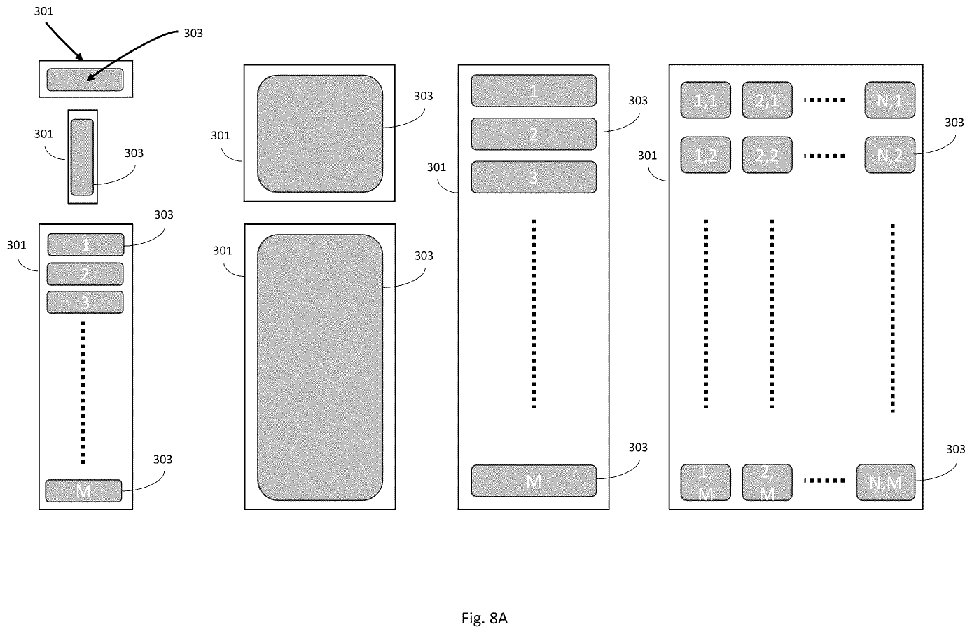

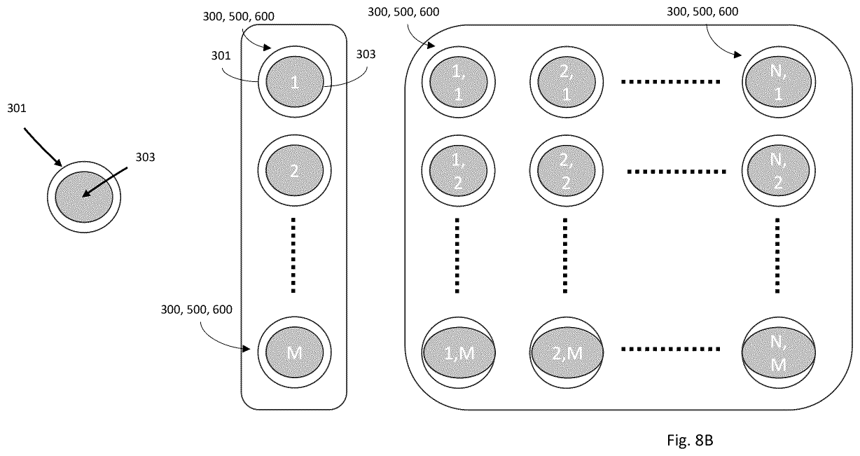

Referring now to FIG. 8A, shown are various dynamic VATs 300, 500, 600 array/matrix configurations, according to some embodiments of the present disclosure. In some embodiments, one or more substrate VATs 303 may be configured in an array in a container VAT 301. The array of substrate VATs 303 may be a linear array including first though M substrate VATs 303 or a two-dimensional array including N×M array of substrate VATs 303 in the container VAT 301. Each of the substrate VATs 303 in the array of VATS may be individually addressable and movable to an adjacent array position in the array and actuatable in the X, Y, Z, and A pitch directions. In some embodiments, the substrate VAT 303 may be positioned in multiple shapes and arrangements within the container VAT 301. In some embodiments the container VAT 301 and the substrate VAT 303 may follow JEDEC standards for matrix and substrate carrier trays. In some instances, the substrate VATs 303 may be actuated/controlled as a group. In other instances, the substrate VATs 303 may be actuated/controlled individually.

Referring now to FIG. 8B, shown are various dynamic VAT 300, 500, 600 array/matrix configurations, according to some embodiments of the present disclosure. In some embodiments, one or more substrate VATs 303, in a respective container VAT 301, may be configured in a linear or two-dimensional array. In some embodiments, each dynamic VAT 300, 500, 600, including the respective container VAT 301 and substrate VAT 303, may be precisely controlled or actuated by group or individually using software control to about the array. In some instances, the substrate VATs 303 may be positioned in multiple circular shapes and arrangements within a container VAT 301.

In an embodiment, the vacuum/pump system 326 is coupled to one or more container VAT material inlet/outlet apertures or ports on each individual array or matrix element enabling the removal, replacement, or maintenance of liquid material on selective or configurable basis to each substrate VAT (see, e.g., FIGS. 3A, 5, 7A, 7B). In this manner, the amount of liquid material can be controlled for individual substrate VAT within the array or matrix.

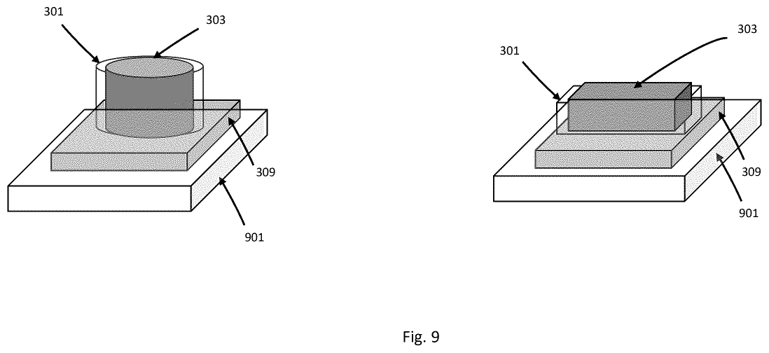

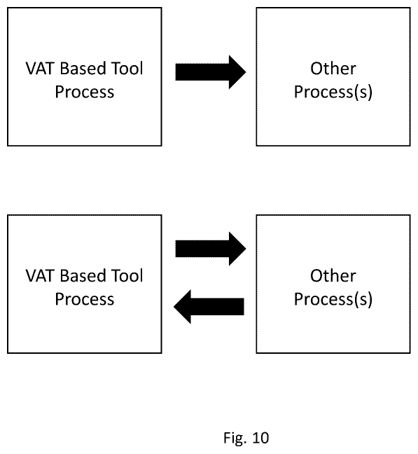

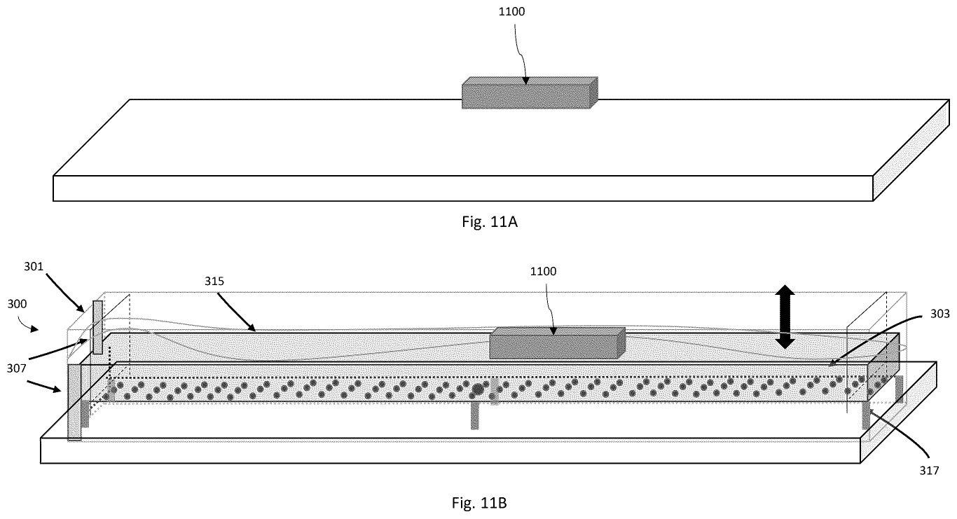

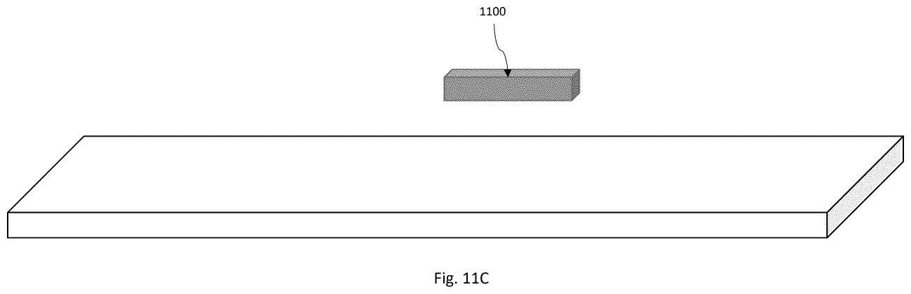

Referring now to FIGS. 9 and 10, shown is dynamic VAT 300, 500, 600 for use in VAM mounted on a motion platform 901. In some embodiments, the dynamic VAT 300, 500, 600 may be used in conjunction with other manufacturing and additive manufacturing processes. The dynamic VAT 300, 500, 600, mounted on the motion platform 901, is movable within a manufacturing environment to be able to position the dynamic VAT 300, 500, 600 under other tools for further processing. FIG. 10 illustrates an exemplary embodiment depicting how dynamic VAT 300, 500, 600 integrates VAM with other tools and/or manufacturing processes. For example, as illustrated in FIGS. 11A-11C, after the 3D object is fabricated using VAM, the substrate VAT 303 is raised to expose the 3D object for further manufacturing processes, for example cleaning or curing. The dynamic VAT 300, 500, 600 can be moved, via the motion platform 901, between various tools to clean, cure, or have additional features added using other additive manufacturing processes. The substrate VAT 303 and 3D object may be lowered back into liquid 315 for further VAM processing.

In an embodiment, the container VAT 301 or substrate VAT 303 may individually or collectively be removed or decoupled from the build platform adapter 309, or the motion platform 901 to facilitate insertion or removal of the various VAT components described.

FIG. 11A shows a 3D object 1100 fabricated using VAM submerged in the liquid 315. FIG. 11B shows a 3D object 1100 fabricated using VAM partially submerged in the liquid 315. FIG. 11C shows a 3D object 1100 fabricated using VAM fully emerged from the liquid 315.

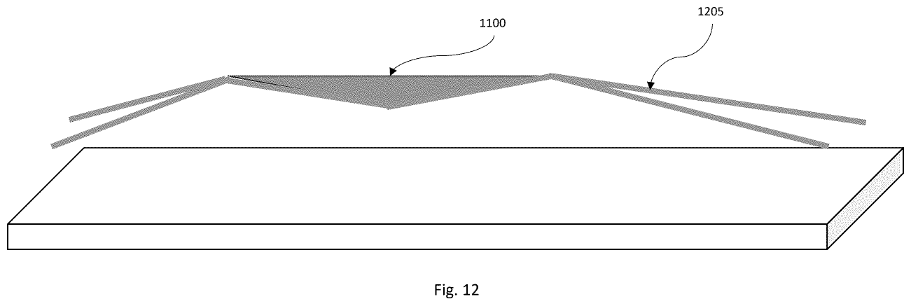

Referring now to FIG. 12, shown is a dynamic VAT 300 with a substrate VAT 1203 having a variable geometry build platform 1205. The 3D object 1100 fabricated using VAM is printed on the build platform 1205 of the substrate VAT 1203, with a base of the 3D object 1100 being formed on the build platform 1205 of the substrate VAT 1203. In some embodiments, the build platform 1205 may have a non-uniform geometry having a variable surface. For example, the build platform 1205 may have one or more features such as protrusions, sloped surfaces, or other fixtures which the 3D object 1100 is printed on. In this way, 3D objects 1100 having various geometries can be formed in various orientations as desired and be supported by the surface of the build platform 1205.

As illustrated in FIG. 12, the 3D object 1100 has a triangular shape and is being printed with the apex oriented towards the build platform 1205. Normally printing a triangular shape in an inverted orientation with the apex pointed downward would necessitate print support structures; however, by using a substrate VAT 1203 with a variable geometry build platform 1205, the 3D object 1100 can be printed directly on the build platform 1205. It is appreciated that a given substrate VAT 1203 may have a build platform 1205 with any desired geometry, linear and non-linear, with any number of features as desired for a given application. in some embodiments the substrate VAT 1203 with variable geometry build platform 1205 may be used in place of or in addition to the substrate VAT 303. In some embodiments, the build platform 1205 may be dynamically variable, having one or more movable features that can adjust the surface of the build platform 1205 in real time, between or during printing operations, to facilitate different VAM applications.

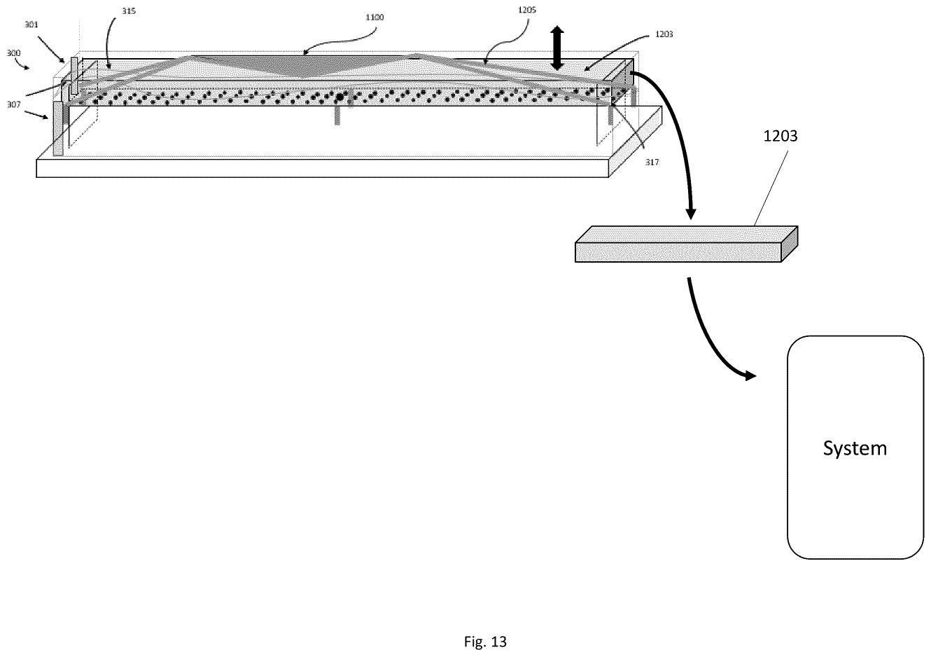

As illustrated in FIG. 13, the dynamic VAT 300 supports the separation of or the decoupling of the substrate VAT 1203 from the system such that the substrate VAT 1203 may be handled and utilized directly with other tools or systems, for example, post processing systems or other additive manufacturing systems. In this manner the substrate VAT 1203 functions as a part tray or carrier for transport and/or insertion into additional systems that execute additional fabrication processing steps.

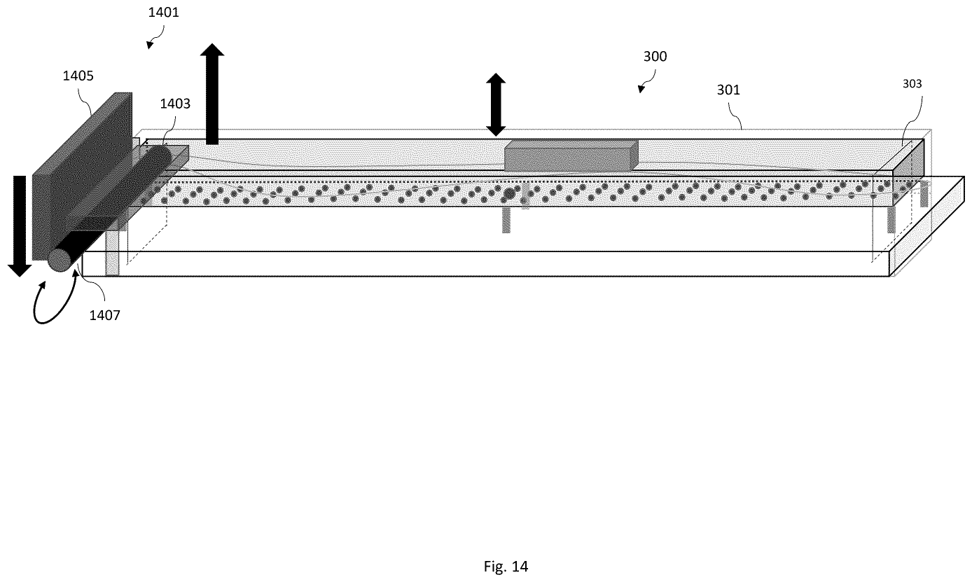

Referring now to FIG. 14, shown is the dynamic VAT 300 with a mechanical actuator 1401 for adjusting the position of the substrate VAT 303, according to some embodiments of the present disclosure. The mechanical actuator 1401 may include an attachment segment 1403 and an actuation segment 1405 operatively coupled to the attachment segment 1403 by a drive train 1407. The drive train 1407 may be any arrangement of one or more gears, axles, transmissions, magnetic linkages, or other components to transfer motion of the actuation segment 1405 to the attachment segment 1403. As the actuation segment 1405 is moved in the +/−Z direction the drive train 1407 translates the movement to attachment segment 1403 to move the attachment segment 1403 in a respective +/−Z direction. In some embodiments, direction of the movement of the attachment segment 1403 may be the inverses of the actuation segment 1405.

In some embodiments, a tool or system, for example a robotic arm or robotic end effector, may be used to exert a force on the actuation segment 1405 of the mechanical actuator 1401 to move the actuation segment 1405 and respectively the attachment segment 1403. The attachment segment 1403 may be coupled to a side of the substrate VAT 303, such that as the attachment segment 1403 is moved in the +/−Z direction by the tool or systems, the substrate VAT 303 is moved in the +/−Z direction into and out of the container VAT 301.

In some embodiments, the attachment segment 1403 may be coupled to any side, top, or bottom of the substrate VAT 303, which may be desirable to facilitate flexible locations for use by one or more tools or systems. In some embodiments, one or more mechanical actuators 1401 may be used and coupled to one or more sides of the substrate VAT 303. In some embodiments, each individual mechanical actuator 1401 may be capable of moving the substrate VAT 303 into and out of the container VAT 301 independently. In some embodiments, one or more mechanical actuators 1401 may be used in tandem to move the substrate VAT 303 into and out of the container VAT 301.

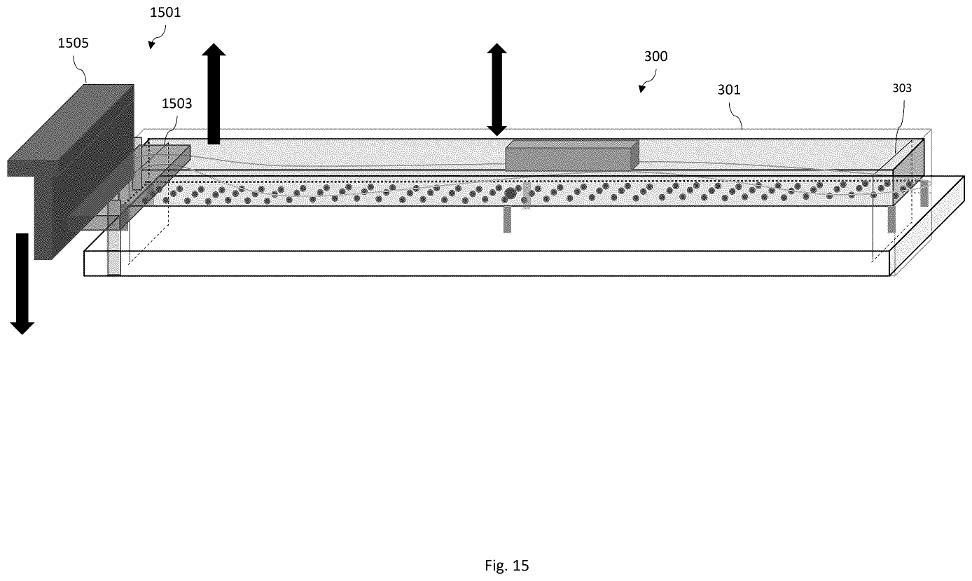

Referring now to FIG. 15, shown is the dynamic VAT 300 with a gripper actuator 1501 for adjusting the position of the substrate VAT 303, according to some embodiments of the present disclosure. The gripper actuator 1501 may be similar to the mechanical actuator 1401 and may include an attachment segment 1503. The gripper actuator 1501 may also include a gripping or shelf segment 1505 coupled to attachment segment 1503. As the shelf segment 1505 is moved in the +/−Z direction, the attachment segment 1503 coupled thereto is moved in a respective +/−Z direction.

In some embodiments, a tool or system, for example a robotic arm or gripping actuator, may be used to grip or otherwise exert a force on the shelf segment 1505 to then move the shelf segment 1505 and the attachment segment 1503 coupled thereto. The attachment segment 1503 may be coupled to a side of the substrate VAT 303, such that as the shelf segment 1503 is moved in the +/−Z direction by one or more tools or systems, the substrate VAT 303 is moved in the +/−Z direction into and out of the container VAT 301. In some embodiments, the tool or system may act as a type of “pick and place” mechanism whereby the tool or system grips the shelf segment 1505 and is able to pick up and move the substrate VAT 303 in the X, Y, and Z directions and/or any rotational directions as desired. In some embodiments, the substrate VAT 303 may be moved via the gripper actuator 1501 to be moved and placed into another container VAT 301 in the dynamic VAT 300, into another dynamic VAT 300, or to a secondary area for further processing, although not limited thereto.

In some embodiments, the attachment segment 1503 may be coupled to any side, top, or bottom of the substrate VAT 303, which may be desirable to facilitate flexible locations for one or more tools or systems. In some embodiments, one or more gripper actuators 1501 may be used and coupled to one or more sides of the substrate VAT 303. In some embodiments, the substrate VAT 303 may be moved into and out of the container VAT 301 by a tool or system gripping at least one of the one or more gripper actuators 1501.

In some embodiments, the mechanical actuator 1401 and/or the gripper actuator 1501 may be used in in place of or in combination with each other, the Z motion actuator 305 or the magnetic actuator 511.

The following clauses further define particular aspects and embodiments of the present disclosure.

Clause 1. A dynamic VAT for additive manufacturing including a container VAT including a liquid material, a substrate VAT movably disposed in the container VAT, the substrate VAT having a plurality of apertures to allow the liquid material in the container VAT to flow into and out of the substrate VAT, and one or more actuators operably coupled to the substrate VAT and configured to move the substrate VAT in at least a Z direction relative to the container VAT, wherein the one or more actuators are configured to move the substrate VAT between a first position submerged in the liquid material and a second position emerged from the liquid material.

Clause 2. The dynamic VAT of clause 1, wherein the one or more actuators are mechanical linear actuators.

Clause 3. The dynamic VAT of any of the preceding clauses, wherein the one or more actuators are magnetic levitation actuators.

Clause 4. The dynamic VAT of any of the preceding clauses, wherein each of the one or more actuators are individually addressable and actuatable.

Clause 5. The dynamic VAT of clause 4, wherein the substrate VAT is further movable in a X direction, a Y direction, and an A pitch, or B rotation direction relative to the container VAT.

Clause 6. The dynamic VAT of any of the preceding clauses, further including an insert positioned within each of the plurality of apertures, the insert is configured to restrict flow of the liquid material through the respective aperture.

Clause 7. The dynamic VAT of any of the preceding clauses, further including a shutter disposed over one or more of the plurality of apertures, the shutter being movable between an open position and a closed position; wherein when the shutter is in the open position the flow of the liquid material through the apertures is unrestricted and when the shutter is in the closed position the flow of the liquid material through the apertures is restricted.

Clause 8. The dynamic VAT of any of the preceding clauses, further including one or more sensor for detecting a level of the liquid material in the container VAT and the substrate VAT.

Clause 9. The dynamic VAT of clause 8, wherein the one or more actuators adjusts a position of the substrate VAT to compensate for vibrations and to level the substrate VAT based on the level of the liquid material in the container VAT and the substrate VAT.

Clause 10. The dynamic VAT of any of the preceding clauses, wherein the substrate has a non-uniform base to conform to a 3D object being printed.

Clause 11. The dynamic VAT of any of the preceding clauses, further including a vacuum/pump system fluidly coupled to at least one of the plurality of apertures.

Clause 12. The dynamic VAT of clause 11, wherein the vacuum/pump system is configured to add, remove, or maintain the liquid material within the container VAT and/or the substrate VAT.

Clause 13. The dynamic VAT of any of the preceding clauses, wherein the dynamic VAT is configured to rotate to produce a uniform layer of liquid material.

Clause 14. An additive manufacturing assembly, the additive manufacturing assembly including a motion platform, and a dynamic VAT movable relative to the motion platform, the dynamic VAT including a substrate VAT including a variable geometry build platform, wherein the variable geometry build platform is adjustable relative to the motion platform, wherein the variable geometry build platform defines an engagement surface, the engagement surface being configured to fabricate an object thereon, wherein the dynamic VAT is configurable to move between a first position and a second position relative to the motion platform.

Clause 15. The additive manufacturing assembly of clause 14, wherein the second position of the dynamic VAT is a secondary processing position.

Clause 16. The additive manufacturing assembly of clause 15, wherein the secondary processing position is selected from the group including a tool processing position, a cleaning position, a curing position, and combinations thereof.

Clause 17. The additive manufacturing assembly of any of clauses 14-16, wherein the dynamic VAT further includes a container VAT including a liquid material, wherein the substrate VAT is movable relative to the container VAT, wherein the substrate VAT is movable between a first position submerged in the liquid material and a second position emerged from the liquid material.

Clause 18. The additive manufacturing assembly of any of clauses 14-17, wherein the dynamic VAT further includes a container VAT including a liquid material, the substrate VAT having a plurality of apertures to allow the liquid material in the container VAT to flow into and out of the substrate VAT, and one or more actuators operably coupled to the substrate VAT and configured to move the substrate VAT in at least a Z direction relative to the container VAT, wherein the one or more actuators are configured to move the substrate VAT between a first position submerged in the liquid material and a second position emerged from the liquid material.

Clause 19. The additive manufacturing assembly of any of clauses 14-18, wherein the engagement surface of the variable geometry build platform is adjustable during use.

Clause 20. The additive manufacturing assembly of any of clauses 14-19, wherein the dynamic VAT further includes a liquid material, wherein the dynamic VAT is configured to rotate relative to the motion platform to produce a uniform layer of the liquid material.

The letter designations for the X, Y, and Z axes are for illustration purposes only and are not intended to limit the present disclosure. The use of the X, Y, and Z to define the directional axes and the relative frame of reference associated with the coordinate axes may be interchanged without departing from teachings of the present disclosure.

The descriptions of the various embodiments of the present disclosure have been presented for purposes of illustration but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments described herein.

While the disclosure is provided in detail in connection with only a limited number of embodiments, it should be readily understood that the disclosure is not limited to such disclosed embodiments. Rather, the disclosure can be modified to incorporate any number of variations, alterations, substitutions or equivalent arrangements not heretofore described, but which are commensurate with the spirit and scope of the disclosure. Additionally, while various embodiments of the disclosure have been described, it is to be understood that the exemplary embodiment(s) may include only some of the described exemplary aspects. Accordingly, the disclosure is not to be seen as limited by the foregoing description but is only limited by the scope of the appended claims.

1. A dynamic VAT for additive manufacturing comprising:
a container VAT comprising a liquid material;
a substrate VAT movably disposed in the container VAT, the substrate VAT having a plurality of apertures to allow the liquid material in the container VAT to flow into and out of the substrate VAT; and
one or more actuators operably coupled to the substrate VAT and configured to move the substrate VAT in at least a Z direction relative to the container VAT,
wherein the one or more actuators are configured to move the substrate VAT between a first position submerged in the liquid material and a second position emerged from the liquid material.

2. The dynamic VAT of claim 1, wherein the one or more actuators are mechanical linear actuators.

3. The dynamic VAT of claim 1, wherein the one or more actuators are magnetic levitation actuators.

4. The dynamic VAT of claim 1, wherein each of the one or more actuators are individually addressable and actuatable.

5. The dynamic VAT of claim 4, wherein the substrate VAT is further movable in a X direction, a Y direction, and an A pitch, or B rotation direction relative to the container VAT.

6. The dynamic VAT of claim 1, further comprising an insert positioned within each of the plurality of apertures, the insert is configured to restrict flow of the liquid material through the respective aperture.

7. The dynamic VAT of claim 1, further comprising a shutter disposed over one or more of the plurality of apertures, the shutter being movable between an open position and a closed position;
wherein when the shutter is in the open position the flow of the liquid material through the apertures is unrestricted and when the shutter is in the closed position the flow of the liquid material through the apertures is restricted.

8. The dynamic VAT of claim 1, further comprising one or more sensor for detecting a level of the liquid material in the container VAT and the substrate VAT.

9. The dynamic VAT of claim 8, wherein the one or more actuators adjusts a position of the substrate VAT to compensate for vibrations and to level the substrate VAT based on the level of the liquid material in the container VAT and the substrate VAT.

10. The dynamic VAT of claim 1, wherein the substrate has a non-uniform base to conform to a 3D object being printed.

11. The dynamic VAT of claim 1, further comprising a vacuum/pump system fluidly coupled to at least one of the plurality of apertures.

12. The dynamic VAT of claim 11, wherein the vacuum/pump system is configured to add, remove, or maintain the liquid material within the container VAT and/or the substrate VAT.

13. The dynamic VAT of claim 1, wherein the dynamic VAT is configured to rotate to produce a uniform layer of liquid material.

14. An additive manufacturing assembly, the additive manufacturing assembly comprising:
a motion platform; and
a dynamic VAT movable relative to the motion platform, the dynamic VAT comprising:
a substrate VAT comprising a variable geometry build platform, wherein the variable geometry build platform is adjustable relative to the motion platform, wherein the variable geometry build platform defines an engagement surface, the engagement surface being configured to fabricate an object thereon;
wherein the dynamic VAT is configurable to move between a first position and a second position relative to the motion platform.

15. The additive manufacturing assembly of claim 14, wherein the second position of the dynamic VAT is a secondary processing position.

16. The additive manufacturing assembly of claim 15, wherein the secondary processing position is selected from the group comprising a tool processing position, a cleaning position, a curing position, and combinations thereof.

17. The additive manufacturing assembly of claim 14, wherein the dynamic VAT further comprises a container VAT comprising a liquid material, wherein the substrate VAT is movable relative to the container VAT, wherein the substrate VAT is movable between a first position submerged in the liquid material and a second position emerged from the liquid material.

18. The additive manufacturing assembly of claim 14, wherein the dynamic VAT further comprises:
a container VAT comprising a liquid material;
the substrate VAT having a plurality of apertures to allow the liquid material in the container VAT to flow into and out of the substrate VAT; and
one or more actuators operably coupled to the substrate VAT and configured to move the substrate VAT in at least a Z direction relative to the container VAT,
wherein the one or more actuators are configured to move the substrate VAT between a first position submerged in the liquid material and a second position emerged from the liquid material.

19. The additive manufacturing assembly of claim 14, wherein the engagement surface of the variable geometry build platform is adjustable during use.

20. The additive manufacturing assembly of claim 14, wherein the dynamic VAT further comprises a liquid material, wherein the dynamic VAT is configured to rotate relative to the motion platform to produce a uniform layer of the liquid material.
